(19) United States
(12) Patent Application Publication
(10) Pub. No.: US 2004/0164512 A1
(43) Pub. Date: Aug. 26, 2004

(54) Wagon and steering assembly

(76) Inventors: David M. Gunter, Kettering, OH (US); John E. Fowler, Centerville, OH (US)

Correspondence Address: DINSMORE & SHOHL, LLP, 1900 CHEMED CENTER, 255 EAST FIFTH STREET, CINCINNATI, OH, 45202, US

(21) Appl. No.: 10/374,558

(22) Filed: Feb. 25, 2003

(51) Int. Cl. B62M 1/00

(52) U.S. Cl. 280/87.021

(57) ABSTRACT

A wagon and steering assembly featuring a stationary rotation mount, a rotation sleeve rotatably mounted over at least part of the rotation mount and a steering mechanism mounted to the rotation sleeve including two oppositely spaced wheels each rotatably connected the steering mechanism. The wagon may also include two such steering assemblies cross-linked so that when first of the steering mechanisms is moved in one direction, the second of the steering mechanisms is moved in the opposite direction.

### FIELD OF THE INVENTION

The present invention relates to wagons and wheel support/steering assemblies for wagons and similar vehicles.

### BACKGROUND OF THE INVENTION

Basic coaster and utility wagons and steering assemblies are known in the art. Such wagons generally comprise a bottom wall, front and rear walls and two side walls thereby forming a box. The steering assemblies associated with such wagons generally comprise a turntable with one end mounted to the underside of the wagon body and a bolster mounted to the opposite end of the turntable. The bolster may include crosswise aligned openings through which a front axle extends for rotational mounting of wheels. A handle may be secured to the front end of the bolster to rotate the front axle from side to side for steering. Generally, the rear axle is stationary and is secured to the wagon by a bracket assembly.

The present invention recognizes and addresses some of the problems with basic wagons and their wheel support/steering assemblies. First, the rotation of the previous steering assemblies is often encumbered as a result of the association between the turntable and bolster. Also, as previous wagons only provide for steering of the front wheels, maneuverability is limited.

Accordingly, there is a desire for a wagon and steering assembly arrangements configured to provide fluid steering and increased maneuverability.

### SUMMARY OF THE INVENTION

The present invention is intended to address and obviate problems and shortcomings and otherwise improve previous wagons and steering assemblies employed therein.

To achieve the foregoing and other objects in accordance with the exemplary embodiments of the present invention a wagon and steering assembly comprises a wagon, a stationary rotation mount connected to the wagon, a rotation sleeve rotatably mounted over at least a part of the rotation mount and a steering mechanism secured adjacent the rotation sleeve and including two oppositely spaced wheels each rotatably connected to the steering mechanism.

To still further achieve the foregoing and other objects of the present invention, an exemplary wagon and steering assembly comprises a wagon bed with a lower surface, a stationary rotation mount connected to the lower surface of the wagon bed, a rotation sleeve rotatably mounted to at least a part of the rotation mount, a steering mechanism secured adjacent the rotation sleeve, and oppositely spaced wheels each rotatably connected thereto.

To even further achieve the foregoing and other objects in accordance with additional exemplary embodiments of the present invention, a wagon and steering assembly may comprise a wagon, a pair of stationary rotation mounts connected to the wagon, rotation sleeves each rotatably mounted over at least a part of each of the rotation mounts and separate steering mechanisms each secured adjacent one of the rotation sleeves and each including a set of oppositely spaced wheels. Such wagon and steering assembly might further comprise rods cross-linking the two steering mechanisms so that when one of the steering mechanisms is moved in one direction, the other of the steering mechanisms is correspondingly moved in the opposite direction.

Still other embodiments, combinations, advantages and objects of the present invention will become apparent to those skilled in the art from the following descriptions wherein there are shown and described alternative exemplary embodiments of this invention for illustration purposes. As will be realized, the invention is capable of other different aspects, objects and embodiments all without departing from the scope of the invention. Accordingly, the drawings, objects, and description should be regarded as illustrative and exemplary in nature only and not as restrictive.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side perspective of the wagon of the present invention illustrating the relative positions of the wheels when the handle is turned to the left;

FIG. 2 is a partial perspective view of an exemplary rotation mount of the present invention FIG. 3 is an exploded view of an exemplary steering assembly of the present invention;

FIG. 4 is a perspective view of an exemplary steering assembly of the present invention including a rotation sleeve, a handle bracket and handle assembly;

FIG. 5 is a partially exploded view of a second exemplary steering assembly of the present invention;

FIG. 6 is a partial bottom perspective view of a wagon of the present invention illustrating an exemplary first cross-linked steering assembly;

FIG. 7 is a partial bottom perspective view of a wagon of the present invention illustrating an exemplary second cross-linked steering assembly;

FIG. 8 is a bottom perspective view of a wagon of the present invention illustrating exemplary cross-linked steering assemblies; and

FIG. 9 is a side perspective view of an exemplary wagon of the present invention illustrating the cross-linked steering assemblies and support members.

### DETAILED DESCRIPTION OF EXEMPLARY EMBODIMENTS

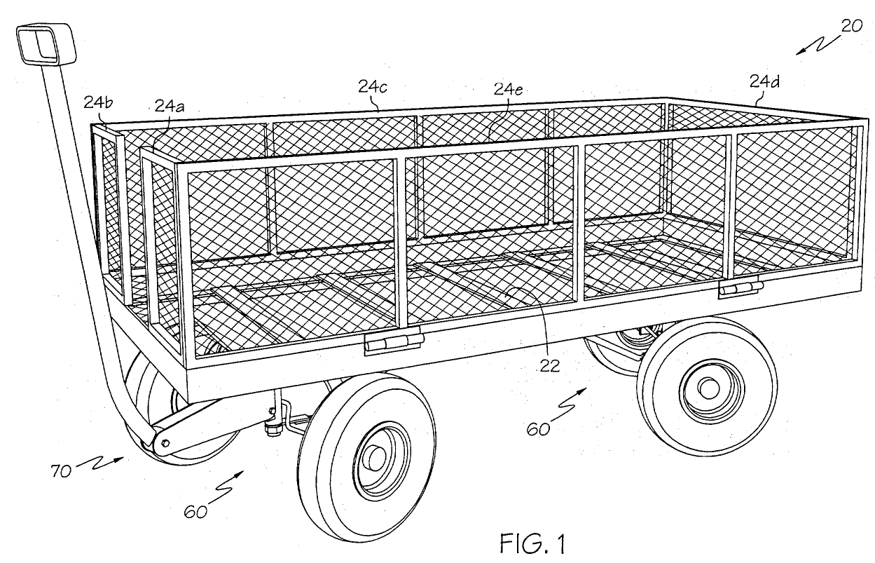

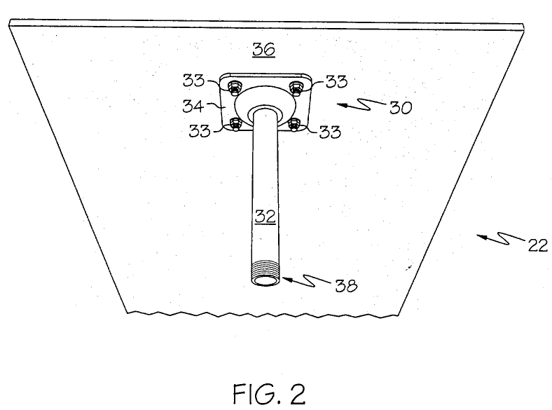

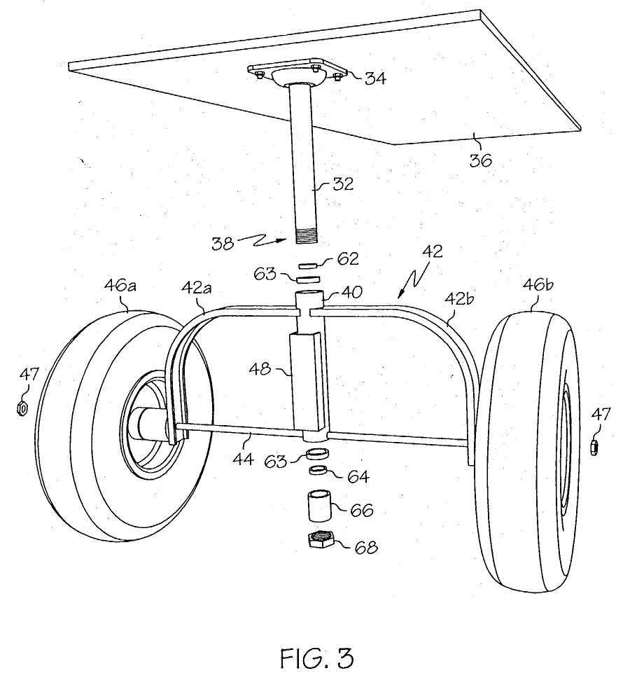

Referring to the drawing figures in detail, wherein like numerals indicate the same elements throughout the drawing figures, FIG. 1 illustrates an exemplary wagon 20 comprising a wagon bed 22 and foldable walls 24a-24e. Wagon 20 may also comprise front and rear steering assemblies 60 including handle assembly 70 for steering wagon 20. While FIG. 1 illustrates a wagon with mirrored front and rear steering assemblies, it is contemplated that a single steering assembly of the present invention may be utilized with a wagon wherein the rear wheels are affixed to a stationary axle, and such is envisioned in the description of FIGS. 2-4 below. Also, it should be understood that steering assemblies of the present invention may be used with a variety of wagon embodiments including, but not limited to, box wagons with a bottom wall, a front and rear wall and two sidewalls or a stake wagon including four sidewalls removeably secured to a wagon box. In addition, while the steering assemblies are described herein as mounted to a “wagon” it is contemplated that these steering assemblies may be mounted to any number of frames capable of supporting such assemblies.

FIGS. 2-4 illustrate a first exemplary steering assembly in accordance with the present invention. Referring to FIG. 2, an exemplary steering assembly may comprise a mounting assembly 30 mounted to the lower surface 36 of a wagon bed 22. The mounting assembly 30 comprises a rotation mount 32 secured to a mounting plate 34. Mounting plate 34 may be secured to the wagon 36 such as with a plurality of fasteners 33 or otherwise. As will be discussed, the rotation mount 32 provides an anchor surface for rotational mounting of a rotation sleeve. The rotation mount 32 and mounting plate 34 may be made of steel or any other durable material. The rotation mount 32 may be welded to the mounting plate 34 and may comprise a hollow cylindrical tube with a threaded distal end 38 for securing the remaining components of the steering assembly thereto. It should be understood, however, that rotation mount 32 may be secured to a wagon in a variety of ways including, but not limited to screwing rotation mount 32 into the mounting plate 34, bonding or welding rotation mount 32 directly to the wagon bed 22, or securing rotation mount 32 to one or more arms and mounting the arms to the wagon bed 22 or wagon itself.

As illustrated in FIG. 3, the steering assembly of the present invention may also comprise a rotation sleeve 40 configured to be rotatably fitted at least partially around and/or telescopingly over rotation mount 32. The rotation sleeve 40 can be made of steel or any other durable material. In addition, the rotation sleeve 40 may be configured so that its inner diameter is slightly larger than the outer diameter of the rotation mount 32. Such configuration may allow free rotation of rotation sleeve 40 about rotation mount 32 while limiting cant or tilt between sleeve 40 and mount 32 for alignment and stability purposes. For example, in one embodiment, the inner diameter of sleeve 40 may be 2″ (5 cm) while the outer diameter of mount 32 may be 1 ¾″ (4.4 cm). In such embodiment, sleeve 40 may easily slide over mount 32 providing free, unencumbered, rotation about the mount 32.

Additional components of the steering assembly 60 may be secured to rotation sleeve 40. For example, as illustrated in FIG. 3, steering mechanism 42 may further comprise a yoke including right and left L-shaped arms 42a and 42b which may be secured to sleeve 40. In another embodiment, steering mechanism 42 may comprise a yoke including a single piece of (e.g. U-shaped) material secured in same way to sleeve 40. Each arm 42a and 42b of steering mechanism 42 may comprise a flat piece of steel bent on both sides to form a channel 43 between the bends. Also, each arm 42a and 42b may be configured so that one end may be secured adjacent sleeve 40 and the other end may be secured to axle 44, such as illustrated in FIG. 3. While steering mechanism 42 of FIG. 3 may be provided of steel and welded to sleeve 40, it should be understood that steering mechanism 42 may alternatively be comprised of any other durable material and be secured to sleeve 40 by a fastener or any other mounting apparatus. In another embodiment, steering mechanism 42 and sleeve 40 may comprise a unitary structure formed by casting, molding or forging.

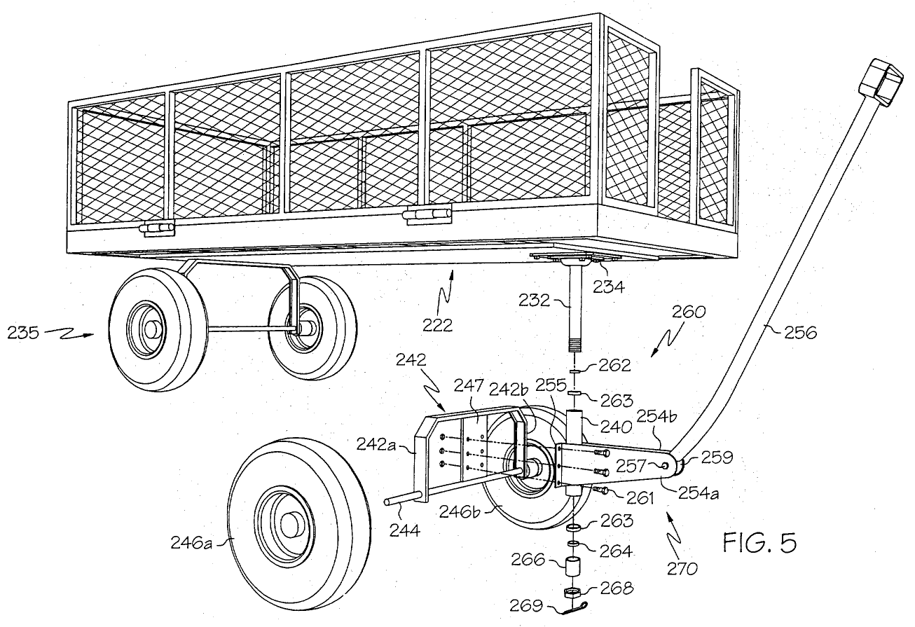

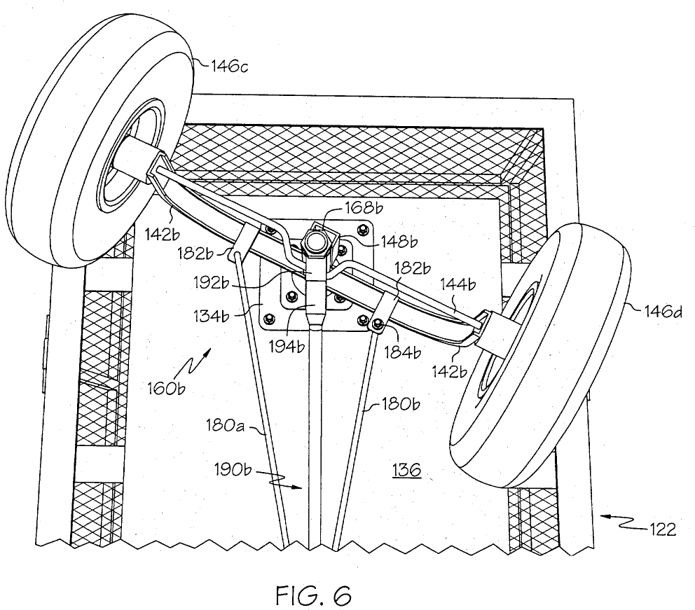

The axle 44 may extend through apertures located in the distal end of each arm 42a and 42b of steering mechanism 42. Axle 44 may be comprised of steel or any other durable material and may be configured for rotatable mounting of wheels 46a and 46b. A nut 47 may be used to secure wheels 46a and 46b to the axle 44. In another embodiment, wheels 46a and 46b may be rotatably mounted directly to steering mechanism 42 without a common axle. As illustrated in FIG. 3, axle 44 may be provided in the form of rod extending behind and welded to sleeve 40. In another embodiment, axle 44 may include a U-shaped curve positioned toward the center of axle 44 configured to allow axle 44 to closely conform to and/or fit around sleeve 40 (See 144a and 144b in FIGS. 5 and 6). In addition, steering mechanism 42 may support axle 44 at any point along the length of axle 44.

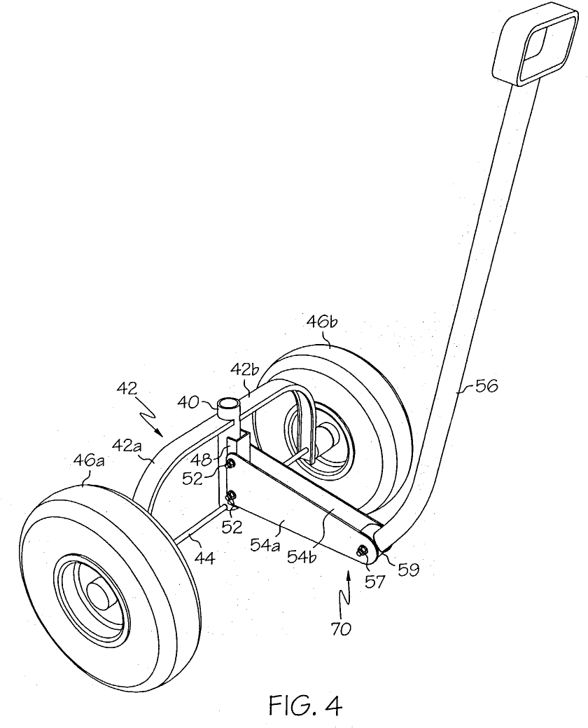

Another component of the steering assembly that may be secured to rotation sleeve 40 includes a handle bracket. Referring to FIG. 4, a handle bracket 48 for securely mounting a handle assembly 50 thereto is illustrated as an example. Handle bracket 48 may be a U-shaped bracket comprised of steel or any other durable material and may be welded or otherwise secured at any position along sleeve 40. In addition, handle bracket 48 may accept fasteners 52 such as bolts, screws, rivets or the like through apertures located on the bracket 48. As will be understood, connection of the handle with sleeve 40 enables a user to correspondingly control the rotation of sleeve 40 and steering mechanism 42.

In the illustration of FIG. 4, the handle assembly 50 may comprise two tongues 54a and 54b secured to a handle 56. Tongues 54a and 54b may also be secured to handle bracket 48 at their proximal end by inserting fasteners 52 through apertures in tongues 54a and 54b and handle bracket 48. Tongues 54a and 54b may also be rotatably secured to handle 56 at their distal ends by inserting fastener 57 through apertures at the distal end of each tongue 54a and 54b and the aperture at the proximal end of the handle 56. If desired, the proximal end of the handle 56 may be fitted with a combination spacer or bushing 59 designed to prevent space between handle 56 and tongues 54a and 54b. Bushing 59 may be comprised of rubber, plastic or other such material to facilitate rotation of the handle 56 about tongues 54a and 54b. It should be understood that FIG. 4 illustrates but one embodiment for securing handle 56 to the steering assembly and that many other handle assembly embodiments are contemplated by the present invention including, but not limited to, mounting tongues 54a and 54b directly to sleeve 40 or rotatably mounting handle 56 directly to sleeve 40.

Referring again to FIG. 3, a first bearing 62 may be positioned between mount 32 prior to mounting rotation sleeve 40 to facilitate rotation of sleeve 40 about mount 32. As previously discussed, rotation sleeve 40 may be configured so that its inner diameter corresponds with and is slightly larger than the outer diameter of rotation mount 32. Once rotation sleeve 40 is positioned over rotation mount 32, a second bearing 64 may be positioned adjacent to distal end of rotation mount 32 to further facilitate rotation of sleeve 40 about mount 32. If desired, a bearing race 63 may be inserted into each end of sleeve 40 to hold bearings 62 and 64. Once sleeve 40 is positioned over rotation mount 32 the threaded end 38 of rotation mount 32 may protrude somewhat out of the distal end of sleeve 40. If distal threaded end 38 extends out of rotation sleeve 40 at a distance whereby non-threaded portion of rotation mount 32 is exposed, an appropriately sized spacer 66 may be positioned over rotation mount 32 to cover any part of exposed non-threaded mount 32. Once the components of steering assembly 60 are positioned over rotation mount 32, one or more nuts 68 may be secured onto threaded distal end 38 thereby maintaining the steering assembly 60 in proper position relative to the underside 36 of the wagon bed 22. If desired, a cotter pin may be inserted through mount 32 to further secure steering assembly 60 to wagon 36. Also, side to side movement may be adjusted by tightening or loosening nut 68. As a result of the association between mount 32 and sleeve 40, the steering assembly 60 of the present invention is capable of smooth, consistent side to side movement.

Referring to FIG. 5, a second of a variety of possible steering assembly embodiments is illustrated. The steering assembly 260 may comprise a rotation mount 232 secured to the wagon bed 222. As illustrated in FIG. 5, wagon may also comprise a conventional a rear stationary axle and bracket assembly 235 mounted to wagon bed 222. As previously discussed, it should be understood that rotation mount 232 may be secured to a wagon in a variety of ways including, but not limited to screwing rotation mount 232 into mounting plate 234, bonding or welding rotation mount 232 directly to the wagon body 222, or securing rotation mount 232 to one or more arms and mounting the arms to the wagon bed 222 or the wagon itself.

As illustrated in FIG. 5, the steering assembly 260 may also comprise a rotation sleeve 240 configured to be rotatably fitted at least partially around and/or telescopingly over rotation mount 232.

Additional components of the steering assembly 260 may be secured to rotation sleeve 240. For example, handle assembly 270 may comprise two tongues 254a and 254b secured to sleeve 240. Tongues 254a and 254b may be secured to sleeve by a weld or other fastening arrangement. Alternatively, tongues 254a and 254b may be secured to rotation sleeve mounting plate 255. As discussed later herein, sleeve mounting plate 255 may be used to secure rotation sleeve 240 and components thereof to steering mechanism 242.

Tongues 254a and 254b may also be rotatably secured to handle 256 at their distal ends by inserting fastener 257 through apertures at the distal end of each tongue 254a and 254b and the aperture at the proximal end of the handle 256. If desired, the proximal end of the handle 256 may be fitted with a combination spacer or bushing 259 designed to prevent space between handle 256 and tongues 254a and 254b.

Steering mechanism 242 may comprise a yoke including right and left L-shaped arms 242a and 242b. Each arm 242a and 242b of steering mechanism 242 may comprise a flat piece of steel bent on both sides to form a channel between the bends. Also, each arm 242a and 242b may be configured so that axle 244 may extend through apertures located in the distal end of each arm 242a and 242b. Axle 244 may be configured for rotatable mounting of wheels 246a and 246b.

Associated with steering mechanism 242 may be a steering mechanism mounting plate 247 configured so that sleeve mounting plate 255 may be mounted thereto by a plurality of fasteners 261. As previously discussed, it should be understood that steering mechanism 242 may be secured directly to or adjacent sleeve 240 in a variety of arrangements including, but not limited to configuring steering mechanism 242 and sleeve 240 as a unitary structure formed by casting, molding or forging.

As illustrated in FIG. 5, once the steering mechanism mounting plate 247 is secured to sleeve mounting plate 255, a first bearing 262 may be positioned around mount 232 prior to mounting rotation sleeve 240 to facilitate rotation of sleeve 240 about mount 232. Once rotation sleeve 240 is positioned over rotation mount 232, a second bearing 264 may be positioned adjacent to distal end of rotation mount 232 to further facilitate rotation of sleeve 240 about mount 232. If desired, a bearing race 263 may be inserted into each end of sleeve 240 to hold bearings 262 and 264. Once sleeve 40 is positioned over rotation mount 232 the threaded end 238 of rotation mount 32 may protrude somewhat out of the distal end of sleeve 240. If distal threaded end 238 extends out of rotation sleeve 240 at a distance whereby non-threaded portion of rotation mount 232 is exposed, an appropriately sized spacer 266 may be positioned over rotation mount 232 to cover any part of exposed non-threaded mount 232. Once the components of steering assembly 60 are positioned over rotation mount 232, one or more nuts 268 may be secured onto threaded distal end 38 thereby maintaining the steering assembly 260 in proper position relative to the wagon bed 222 or the wagon itself. If desired, a cotter pin 269 may be inserted through mount 232 to further secure steering assembly 260 to wagon bed 222. As a result of the association between mount 232 and sleeve 240, the steering assembly 260 of the present invention is capable of smooth, consistent side to side movement.

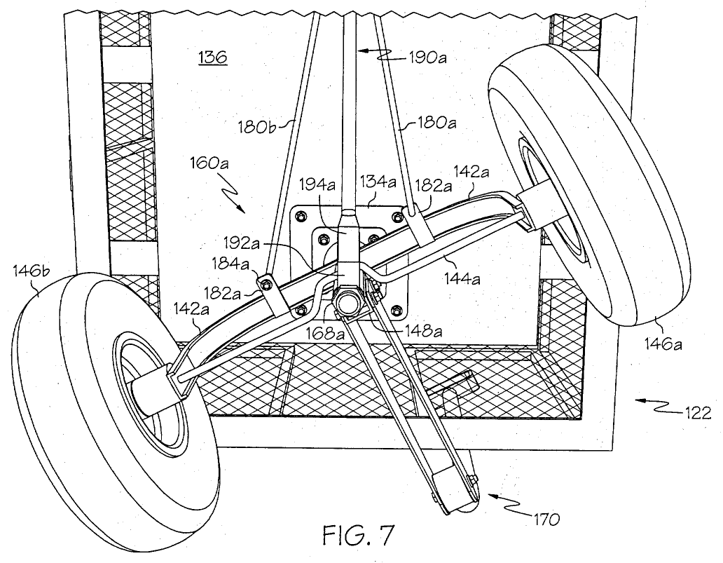

Another aspect of the present invention is that two of the steering assemblies described above may be mounted to the underside of a wagon and cross-linked together, thus providing increased maneuverability. Referring to FIGS. 6 and 7, two steering assemblies 160a and 160b are shown mounted to the lower surface 136 of a wagon bed 122. In such embodiment, the rear steering assembly 160b might take the place of a conventional stationary axle and bracket assembly (235 in FIG. 5). While the steering assembly 160a and 160b are illustrated as resembling the steering assembly illustrated in FIGS. 2-4, as discussed, steering assemblies of the present invention may be configured in a variety of arrangements including, but not limited to the arrangement discussed in FIG. 5. Also, as will be discussed later, steering assemblies 160a and 160b can be linked together by two rods 180a and 180b.

Each steering assembly 160a and 160b may generally comprise a mounting plate 134a and 134b secured to the lower surface 136 of the wagon bed 122 with a rotation mount secured thereto. As previously indicated, the rotation mounts may be secured to the wagon in a variety of ways. In addition, each steering assembly 160a and 160b may also comprise a rotation sleeve configured to be rotatably fitted around the rotation mount. In addition, components of each steering assembly 160a and 160b may be secured adjacent the rotation sleeve such as, for example, a steering mechanism 142a and 142b and a handle bracket 148a and 148b. Front steering assembly 160a may also include a handle assembly 170 secured to handle bracket 148a located on the front steering assembly 160a. Handle assembly 170 may, however, be selectively disconnected from handle bracket 148a of front steering assembly 160a and be secured to handle bracket 148b of rear steering assembly 160b. An axle 144a and 144b may be secured to each steering mechanism and may be configured so that two wheels (e.g. 146) may be rotatably mounted thereto. Once components of the steering assemblies 160a and 160b are mounted to the rotation mount, a nut 168a and 168b may be screwed on the rotation mounts to secure the steering assemblies 160a and 160b to the lower surface 136 of the wagon bed 122.

Referring to front steering assembly 160a (FIG. 6), two tabs 182a may be secured to the steering mechanism 142a to facilitate connection of rods 180a and 180b therein. Tabs 182a may be made of sheet steel or any other durable material capable of withstanding wear and stress. In one embodiment, one end of each tab 182a may be secured to steering mechanism 142a by a weld. However, tabs 182a may be secured to any part of the steering assembly 160a including, but not limited to the axle 144a. Also, it is understood that tabs 182a may be secured to the steering assembly 160a by any conventional fastening means or appropriate connection arrangement.

Each tab 182a may also include an aperture for accepting rotatable fasteners for securing ends of one of the rods 180a and 180b. The ends of each rod 180a and 180b may be threaded so that a rod nut 184a can be secured to the ends thereof. In another embodiment, a locking cap may be affixed to the end of each arm to prevent rods 180a and 180b from being removed from tabs 182a. Also, rods 180a and 180b may be welded to tabs 182a, and tabs 182a may be rotatably mounted to steering assembly 160a. In the illustrated example of FIG. 6, once the arms of the rods 180a and 180b are inserted into tabs 182a, a rod nut 184a may be fitted on the end of each rod 180a and 180b to prevent rods 180a and 180b from slipping out of tabs 182a.

The design for rear steering assembly 160b (FIG. 7) can correspond with or mirror front steering assembly 160a, as discussed above. Referring to FIG. 7, the rear steering assembly 160b may comprise two tabs 182b secured to the steering mechanism 142b for disposition of rods 180a and 180b therein. Once the arms of the rods 180a and 180b are inserted into tabs 182b, a nut 184b may be fitted on the end of each rod 180a and 180b to rotatably captivate rods 180a and 180b at tabs 182b. As previously stated, a handle assembly 170 may be mounted to handle bracket 148b of rear steering assembly 160b and/or front steering assembly 160a.

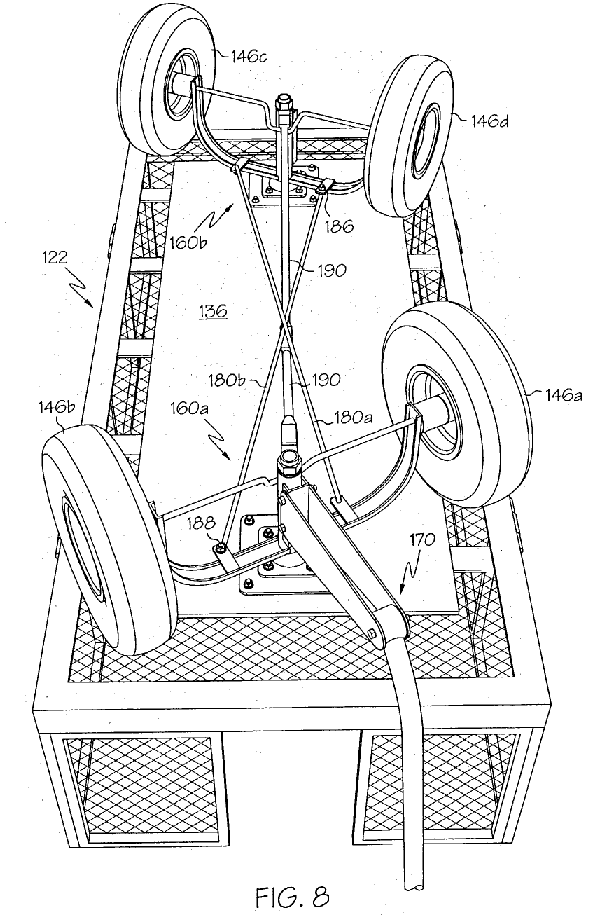

Referring to FIGS. 5-9, rods 180a and 180b may be positioned so that each rod 180a and 180b extends from one tab 182a on the front steering assembly 160a, diagonally across the lower surface 136 of the wagon bed 122, to one tab 182b on the rear steering assembly 160b. As such, the steering assemblies 160a and 160b are said to be “cross-linked.” As illustrated, rods 180a and 180b may include a bend (e.g. at about a 90° angle) at each end, thus providing an arm for rotatable insertion into each of tabs 182a and 182b. In addition, rods 180a and 108b may be oppositely positioned in tabs 182a and 182b to compensate for the overlap between the rods in the center while allowing convenient attachment to respective steering assemblies. For example, in FIG. 8, arms 186 and 188 of rod 180b are bent away from surface 136 of the wagon, while arms of rod 180a are bent upwardly toward the surface 136. Such configuration provides space between rods 180a and 180b to prevent the rods 180a and 180b from rubbing against one another when steering.

Referring again to FIGS. 6-7, front and rear steering assembly support members 190a and 190b may be provided for additional support of the steering assemblies 160a and 160b. The proximal ends of steering assembly support members (e.g. 190a and 190b) may be positioned around the rotation mount and adjacent to the spacer described above (see 66 in FIG. 4). In one embodiment, each proximal end of a pair of support members 190a and 190b may resemble a hollow conventional washer with connecting member 192a and 192b extending outwardly therefrom. In another embodiment, the connecting member (e.g. 192a and 192b) may be welded directly to the spacer (e.g. see spacer 66 in FIG. 4) or the rotation sleeve. The connecting members 192a and 192b may be welded to one end of a steel tube 194a and 194b, respectively, extending toward the center of the wagon. As will be understood, connecting members 192a and 192b could also be provided adjacent the opposite ends of a unitary support member or tube spanning between the respective steering assemblies.

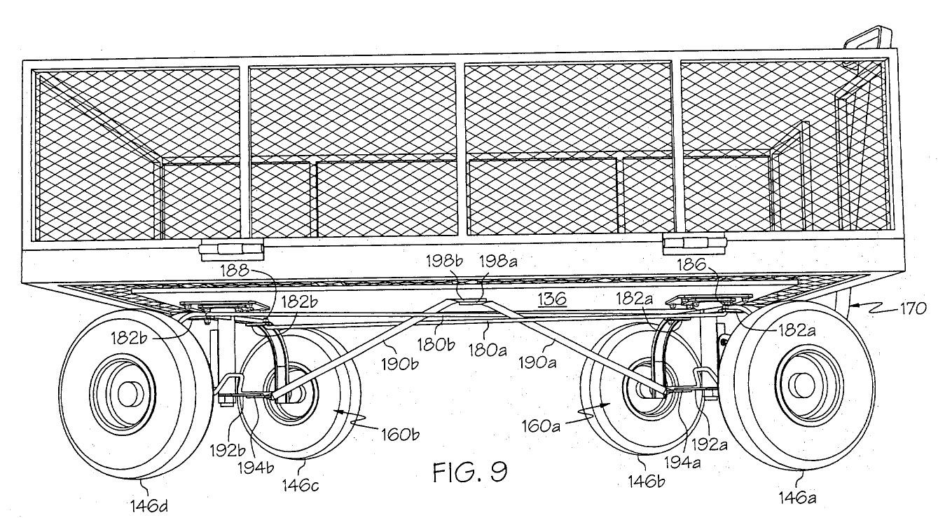

As best seen in FIG. 9, each distal end of support members 190a and 190b may be secured to the underside of the wagon 136. In one embodiment, each distal end of support members 190a and 190b may comprise a flat plate 198a and 198b with a longitudinal aperture for securing support members 190a and 190b to the lower surface 136. Support members 190a and 190b add strength to the steering assemblies of the present invention thereby increasing carrying capacity of wagons employing such steering assemblies.

Referring to FIG. 8, the “cross-linked” steering assemblies are operated by rotation of the handle assembly 170. For example, when handle assembly 170 is rotated in a first direction, the front steering assembly 160a rotates in that first direction of the handle assembly 170. Rods 180a and 180b positioned in the tabs (described above) of front and rear steering assemblies 160a and 160b rotate within the tabs and force rear steering assembly 160b to rotate in the opposite direction of front steering assembly 160a. Therefore, as the front and rear steering assemblies 160a and 160b work in opposite directions, maneuverability increases while steering radius of the wagon decreases.

The foregoing description of the various embodiments of the invention has been presented for the purposes of illustration and description. It is not intended to be exhaustive or to limit the invention to the precise form disclosed. Many alternatives, modifications and variations will be apparent to those skilled in the art of the above teaching. For example, the steering assemblies in accordance with the present invention may be configured in a variety of sizes and be affixed to a variety of wagon frames in different ways. Accordingly, while some of the alternative embodiments of the wagon and steering assembly has been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. A wagon and steering assembly comprising:
a) a wagon;
b) a stationary rotation mount connected to said wagon;
c) a rotation sleeve rotatably mounted over at least a part of said rotation mount; and
d) a steering mechanism secured adjacent said rotation sleeve including two oppositely spaced wheels each rotatably connected thereto.

2. The wagon and steering assembly of claim 1, further comprising a handle bracket secured to said rotation sleeve.

3. The wagon and steering assembly of claim 2, further comprising a handle assembly secured to said handle bracket.

4. The wagon and steering assembly of claim 3, wherein said handle assembly comprises at least one tongue secured to said handle bracket and secured to a handle.

5. The wagon and steering assembly of claim 1, wherein said steering mechanism comprises a yoke secured adjacent said rotation sleeve.

6. The wagon and steering assembly of claim 5, wherein said steering mechanism further comprises an axle connected to two oppositely spaced wheels and having contact with said yoke.

7. The wagon and steering assembly of claim 1, further comprising a steering assembly support member with a first end secured adjacent said rotation sleeve and a second end secured to said wagon.

8. A wagon and steering assembly comprising:
a) a wagon bed with a lower surface;
b) a stationary rotation mount connected to said lower surface of said wagon bed;
c) a rotation sleeve rotatably mounted to at least a part of said rotation mount; and
d) a steering mechanism secured adjacent to said rotation sleeve including two oppositely spaced wheels each rotatably connected thereto.

9. The wagon and steering assembly of claim 8, further comprising a handle bracket secured to said rotation sleeve.

10. The wagon and steering assembly of claim 9, further comprising a handle assembly secured to said handle bracket.

11. The wagon and steering assembly of claim 10, wherein said handle assembly comprises at least one tongue secured to said handle bracket and secured to a handle.

12. The wagon and steering assembly of claim 8, wherein said steering mechanism comprises a yoke secured adjacent said rotation sleeve.

13. The wagon and steering assembly of claim 12, wherein said steering mechanism further comprises an axle connected to two oppositely spaced wheels and having contact with said yoke.

14. The wagon and steering assembly of claim 8, further comprising a steering assembly support member with a first end secured adjacent said rotation sleeve and a second end secured to said wagon.

15. A wagon and steering assembly comprising:
a) a wagon;
b) a pair of stationary rotation mounts connected to said wagon;
c) a pair of rotation sleeves each rotatably mounted over at least a part of each of said rotation mounts; and
d) separate steering mechanisms each secured adjacent one of said rotation sleeves including two sets of oppositely spaced wheels each of said sets rotatably connected to each of said steering mechanisms; and
e) two rods cross-linked to said two steering mechanisms so that when one of said steering mechanisms is moved in one direction, the other of said steering mechanisms is moved correspondingly in the opposite direction.

16. The wagon and steering assembly of claim 15, further comprising a handle bracket secured to each of said rotation sleeves.

17. The wagon and steering assembly of claim 16, further comprising a handle assembly secured to one of said handle brackets.

18. The wagon and steering assembly of claim 15, wherein each of said steering mechanisms comprises a yoke secured adjacent said rotation sleeve.

19. The wagon and steering assembly of claim 18, wherein each of said steering mechanisms further comprise an axle connected to two oppositely spaced wheels and having contact with said yoke.

20. The wagon and steering assembly of claim 15, further comprising two steering assembly support members each with a first end secured adjacent one of said rotation sleeves and each with a second end secured to said wagon.
